(19) United States
(12) Patent Application Publication
(10) Pub. No.: US 2007/0180675 A1
(43) Pub. Date: Aug. 9, 2007

(54) Method and device for mounting axle module

(76) Inventors: Shingo Tsujihama, Tokyo (JP); Hitoshi Sasaki, Tokyo (JP)

Correspondence Address: SMITH, GAMBRELL & RUSSELL, 1850 M STREET, N.W., SUITE 800, WASHINGTON, DC, 20036, US

(21) Appl. No.: 11/572,014

(22) PCT Filed: Jul. 22, 2005
(86) PCT No.: PCT/JP05/13450

§ 371 Date: Jan. 12, 2007

(30) Foreign Application Priority Data
Jul. 23, 2004 (JP) 2004-215834

(51) Int. Cl. B23Q 17/00; B21D 53/88

(52) U.S. Cl. 29/407.1; 29/897.2

(57) ABSTRACT

Mounting of an axle module to a chassis frame is carried out in vertically normal orientation (not in an inverted state). In the process, no heavy-duty equipment or steps are required to hoist chassis frames in the air and turn them upside down. The ceiling space above production lines is reduced. A method and a device are provided for mounting axle modules that are suitable for supplying to a rotary assembly stand. An axle module is transported to a first support stand in normal orientation and a chassis frame is transported to a second support stand also in normal orientation. By lifting the first support stand its mounting ends are aligned with the mounting brackets of the chassis frame. Cylinder means and hovering means are used for lifting.

### TECHNICAL FIELD

The present invention is used in the assembly of vehicles. The present invention relates to a work method and a device for mounting an axle module to a chassis frame. The present invention relates to a work method, whereby work on axle modules and chassis frames at a work location is carried out while holding them in normal orientation, without vertical inversion, as well as to a device used in this work method. The present invention is related to a prior application (Patent document 1) by the present applicant(s).

### BACKGROUND ART

Methods, wherein work is performed after a chassis frame is turned upside down, have been widely used in the past in the process of mounting axle modules to chassis frames (see Patent document 1). Namely, the process has been set up such that mounting work is carried out in a state, wherein a chassis frame is arranged in its work area in a vertically inverted state (with the body-mounting side at the bottom) and axle modules, which are normally located at the bottom of a frame, are lowered from above the chassis frame and placed onto the chassis frame. This is mostly due to the fact that when a chassis frame is in normal orientation (with the body-mounting side at the top and the axle-mounting side at the bottom), the distance between the chassis frame and the surface of the floor is reduced, which makes it difficult for personnel to access the bottom of a chassis frame. For this reason, in the past, vehicle assembly required an operation, wherein after attaching axle modules to a chassis frame, the chassis frame was hoisted up and rotated through 180 degrees about the chassis frame's longitudinal axis with the help of large-scale equipment including crane devices, whereupon the chassis frame was lowered into work position.

Patent Document 1: JP2004-291954 A and WO2004/080785

Non-patent Document 1: “Jidousha gijutsu handobukku” (“Automotive Technology Handbook”), Vol. 4, Production-Quality-Maintenance, edited and published by the Society of Automotive Engineers of Japan, Sep. 1, 1991; in particular, see pp. 283-286.

### DISCLOSURE OF THE INVENTION

### Problems to be Solved by the Invention

For this reason, production facilities engaged in vehicle assembly require heavy-duty crane devices or similar mechanical equipment in order to be able to hoist entire chassis frames and turn them upside down while firmly holding them in the air. In addition, the large-scale mechanical equipment used for this purpose must be designed to accommodate vehicles of the maximum dimensions that can be manufactured at the plant. For this reason, an extremely large ceiling space is required for conventional vehicle assembly lines in order to fit the large-scale mechanical equipment in the air thereabove, which leads to an increase in the scale of the plant building itself.

Patent document 1 discloses a new method and a device for assembly of vehicles on a rotary assembly stand rather than by moving vehicles subject to assembly along a rectilinear production line. Namely, it describes an operational setup, in which vehicles subject to assembly operations are placed on a disk-like stand one by one (or several at a time) and assembly operations are carried out while slowly rotating the stand. The disk-like rotary assembly stand rotates, for instance, once every several tens of minutes. During such time, modules necessary for vehicle assembly are continually supplied from radially located peripheral staging areas towards the center of the rotary assembly stand. Then, just as one full turn of the rotary assembly stand is completed and the vehicle reaches a state where it is capable of self-propelled motion, a driver gets into the vehicle, starts the engine, and drives off the rotary assembly stand in self-propelled mode.

It is understood that the use of the vehicle assembly process disclosed in Patent document 1 will permit a reduction in the scale of mass assembly plants and, at the same time, will make it possible to reduce the number of work-in-process (WIP) components, will permit a decrease in the time spent by the WIP components at the plant, and will enable savings in terms of interest rates related to automobile assembly. This new vehicle assembly process is particularly advantageous when the specifications of the assembled vehicles are not uniform. In addition, it has been recognized that in this new vehicle assembly process, crane devices installed in the space above assembly work stations are limited to sufficiently simple equipment used for individual transportation of the required modules and installation of large-scale equipment used for hoisting and turning vehicle frames upside down is not appropriate.

For this reason, its procedure involves assembling axle modules on a work stand in normal orientation (not in vertically inverted orientation), transporting and positioning a chassis frame above the assembled axle modules, performing alignment to adjust their relative spatial relation, and inserting mounting bolts between the chassis frame and the axle modules. Methods used to perform such alignment include methods, in which the position of the axle modules is fixed and the position of the chassis frame is varied, or methods, in which the position of the chassis frame is fixed and the position of the axle modules is varied. Generally speaking, there are two axle modules, one for the front wheels and one for the rear wheels. By considering them together, we arrived at the idea that a reasonable method involved transporting a chassis frame to a work location, securing it in a fixed position, and performing the respective adjustments by raising the position of the front wheel axle module and rear wheel axle module so as to match the position of the chassis frame.

With this idea in mind, we conducted investigations accompanied by various experiments. When an axle module is brought in proximity to a chassis frame with the help of lifting means and bolts are inserted by aligning mounting ends on the axle module side with mounting ends on the chassis frame side, such an operation requires fine-tuning of their relative position. For this reason, our investigations focused on introducing hovering means. Such hovering means utilizes compressed air to temporarily float a stand, on which an axle module is placed, above its support member. Due to the fact that this permits motion in the horizontal direction (X-Y direction) as well as partially enables motion in the vertical direction (Z-direction), the man-hours of labor required for the insertion of the above-mentioned bolts can be drastically reduced. However, when the hovering means is used for raising, the raising distance is very small and becomes unstable if the hovering means is used for large-distance raising. From these experimental results, it was found that a configuration that combined lifting means with hovering means offered reliable bolt insertion in the shortest possible time, in other words, the greatest reduction in the man-hours of labor.

The object of the present invention, which was made in the course of the above-mentioned investigations, is to simplify the process of vehicle assembly, reduce man-hours, and make the process more economical. It is an object of the present invention to provide a method and a device for eliminating the need for large-scale mechanical equipment installed for raising vehicle frames and turning them upside down in the air, as was done in the past in the process of vehicle assembly. It is an object of the present invention to reduce the man-hours of labor involved in the process of mounting axle modules to chassis frames. It is an object of the present invention to provide a method and a device for mounting axle modules on a chassis frame in a manner that permits various vehicle types with partially different specifications to be accommodated in a uniform fashion. It is an object of the present invention to shorten the time spent by WIP components in the process of vehicle assembly and reduce vehicle assembly expenses. It is an object of the present invention to provide a vehicle assembly method and a device suitable for reducing to practice the invention disclosed in the above-mentioned prior application (vehicle assembly using a rotary assembly stand).

### Means for Solving the Problems

A first aspect of the invention is directed toward a work method for axle module mounting including a first step, in which an axle module is placed on a first support stand in normal orientation, a second step, in which a chassis frame is placed on a second support stand in normal orientation so as to be positioned above the axle module, and a third step, in which the first support stand is raised and mounting ends on the axle module are brought in proximity to mounting ends on the chassis frame.

Here, the term “normal orientation” refers to an orientation equivalent to the normal orientation of a vehicle, and not to an inverse one, which is the conventional work method. The first support stand, on its top face, can be suitably provided with projections and recesses or support members ensuring appropriate placement position of the axle module in accordance with the shape of the axle module.

The third step can include a step, wherein the first support stand is raised using pneumatic or hydraulic cylinder means. The third step can be adapted to include a step, wherein the first support stand is floated using the hovering means. The third step can be adapted to include a step, wherein the cylinder means is used to raise the first support stand and the first support stand is then floated using the hovering means. The term “hovering means” refers to means for injecting compressed air between a support stand and a member supporting the support stand from below so as to create an air barrier and, in doing so, float the support stand and be able to freely move it within a prescribed range using a small force.

A second aspect of the invention is directed toward an axle module mounting device comprising a first support stand, on which an axle module can be placed in normal orientation, a second support stand, on which a chassis frame can be placed so as to be positioned above the axle module placed on the first support stand, and raising means capable of raising the first support stand, with an axle module placed thereon, to a position used for mounting to a chassis frame.

The expression “above the axle module placed . . . ” refers to a position thereabove, in which the mounting ends of the axle module placed on the first support stand are brought to the position of the mounting ends provided on the chassis frame by raising or lifting the first support stand. The distance the stand is raised can be, for instance, several centimeters or several tens of centimeters.

The first support stand can be adapted to comprise, as respective separate members, a front wheel support stand used for placing a front wheel axle module thereon and a rear wheel support stand used for placing a rear wheel axle module thereon, with the front wheel support stand and rear wheel support stand provided with respective raising means, and to comprise means for individually actuating their respective raising operation. Such a configuration permits work on the front axle and rear axle to be performed independently.

It is preferably adapted to comprise means for adjusting the distance between the front wheel support stand and rear wheel support stand. This configuration can accommodate a plurality of vehicle types with different distances between the front axle and rear axle using a single piece of equipment.

The raising means can be adapted to comprise cylinder means. The cylinder means may be either pneumatic or hydraulic.

The raising means is preferably adapted to comprise hovering means. The term “hovering means” refers to means for creating an air barrier by injecting compressed air between a stationary member and a member to be raised, thereby floating the member to be raised and allowing it to freely move about within a certain range.

The raising means can be adapted to comprise both the cylinder means and the hovering means and to comprise actuating means for individually actuating either one of the cylinder means or hovering means.

The height of the second support stand (on which a chassis frame is placed) from the surface of the floor is greater than the radius of the wheels mounted on the axle modules (in subsequent steps) and is preferably set to a height allowing operators standing on the surface of the floor to access the chassis frame placed on the second support stand.

The second support stand can be adapted to comprise two pairs of support posts supporting a pair of longitudinally-oriented members forming part of a chassis frame. A plurality of vehicle types with different chassis frame lengths can be accommodated by including means for adjusting the distance between the two pairs of support posts (in the longitudinal and/or transverse direction). The means for adjusting the longitudinal distance between the two pairs of support posts can be adapted to comprise means for associating it with the means for adjusting the distance between the front wheel support stand and rear wheel support stand.

### Effects of the Invention

The present invention eliminates the need for work methods, in which a chassis frame is turned upside down on a work stand and axle modules are mounted on the inverted chassis frame, as has been widely practiced under conventional work methods. Because by doing so chassis frames are fabricated in normal orientation from the start, there is no need to provide heavy-duty equipment for hoisting chassis frames with axle modules attached thereto, turning them upside down in the ceiling space above the work stand, and then lowering them. Accordingly, the plant's ceiling space may be reduced and there is no need to install large-scale crane devices or similar equipment. Putting the invention into practice provides for a drastic reduction in the man-hours of labor required in the process of mounting axle modules to chassis frames. Putting the present invention into practice also provides for smooth vehicle assembly using the rotary assembly stand disclosed in the above-mentioned prior application and offers numerous economic effects, such as being able to reduce the number of WIP components remaining at the plant.

### BRIEF DESCRIPTION OF DRAWINGS

FIG. 1 is a perspective view providing an outline of a method and device used in an embodiment of the present invention.

FIG. 2 is a perspective view of a device used in an embodiment of the present invention (vehicle with a long wheel base).

FIG. 3 is a perspective view of a device used in an embodiment of the present invention (vehicle with a short wheel base).

FIG. 4 is an explanatory diagram of a configuration used for transporting axle modules with the help of a device used in an embodiment of the present invention.

FIG. 5 is an explanatory diagram of a configuration used for transporting chassis frames with the help of a device used in an embodiment of the present invention.

FIG. 6 is a top view of the main portion of a device used in an embodiment of the present invention (when the first support stand is fixed).

FIG. 7 is a top view of the main portion of a device used in an embodiment of the present invention (when the first support stand is not fixed).

FIG. 8 is a side view of a device used in an embodiment of the present invention (state prior to lifting).

FIG. 9 is a side view of a device used in an embodiment of the present invention (stated after lifting).

FIG. 10 is a structural drawing explaining the lifting mechanism of a device used in an embodiment of the present invention.

FIG. 11 is a side view of a device used in an embodiment of the present invention.

### DESCRIPTION OF REFERENCE NUMERALS

1. First support stand.

1f. First support stand used for front wheels.

1r. First support stand used for rear wheels.

2. Second support stand.

3. Edge.

4. Rail.

5. Hoist.

6. Frame.

7. Actuating end.

8. Bracket.

9. Cylinder.

10. Hydraulic unit.

11. Axle module.

12. Chassis frame.

13. Cross bar.

14. Pneumatic nozzle.

15. Pneumatic valve.

### BEST MODE FOR CARRYING OUT THE INVENTION

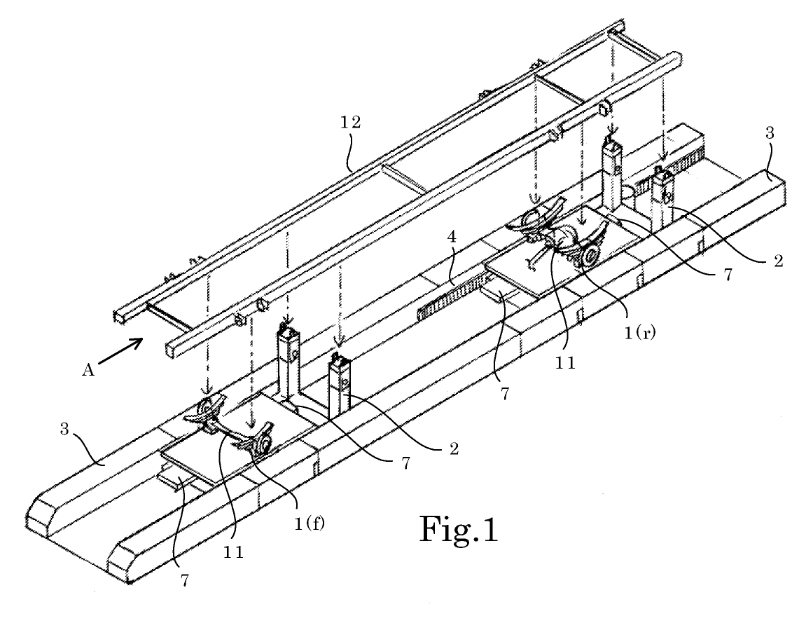

FIG. 1 is a perspective view illustrating a work method used in an embodiment of the present invention, as well as the construction of the main portion of a device used therefor. First support stand 1 and second support stand 2 are configured as an integrated device with a pair of edges 3 arranged on the floor of the plant. The device of this embodiment is arranged on a rotary assembly stand, such as the one used in the previously described prior application. First support stand 1 includes front axle support stand 1(f) and rear axle support stand 1(r), which are designated by letters (f) and (r), in particular, when it is necessary to distinguish between the front axle and rear axle. In FIG. 1, the arrow A indicates the direction of material transport in the device, and it should be noted that the perspective view provided in FIG. 1 was drawn by omitting a number of small accessories in order to facilitate the understanding of the basic construction.

First of all, axle module 11 is transported to the stand. Axle module 11 is transported to the device in the direction of arrow A with the help of a hoist. The hoist has a standard construction and is mounted on rails suspended several meters in the air above the floor of the work station. An operator operating the hoist places axle module 11 onto first support stand 1 in normal orientation by gently guiding axle module 11 with their hands. Axle modules 11 are placed in normal orientation, as illustrated in the figure, separately for front axle module 11(f) and rear axle module 11(r). Let us repeat that the term “normal orientation”, as used here, refers to the original vertical position of a vehicle. To sum up, as explained above, a widely known conventional work method involves carrying out work operations after turning axle modules and chassis frames upside down in the initial stage, and the term “normal orientation”, as used here, means “without inversion” (unlike the conventional work method).

After that, chassis frame 12 is transported, also in the direction of arrow A. It is transported in a similar manner, using a standard hoist, with the operators assisting the process. This chassis frame 12 is placed onto second support stand 2. It is placed in normal orientation as well. As a result, the mounting ends provided at the tips of the leaf springs of axle module 11 are positioned underneath the mounting ends provided on chassis frame 12.

First support stand 1 is configured to be raised when actuated by an operator. In other words, by actuating a hydraulic valve, not shown, an operator supplies hydraulic pressure to a hydraulic cylinder (not shown in FIG. 1 either, but will be explained later) provided in first support stand 1. When the hydraulic cylinder operates, first support stand 1 is slowly raised. When the brackets used for mounting axle module 11 are brought in proximity to the mounting ends provided on chassis frame 12, the operator who operates it stops further hydraulic pressure supply and maintains the hydraulic pressure supplied to the hydraulic cylinder. Doing so maintains the height of axle module 11 at the stop position. Then, by actuating the pneumatic valve, the operator slightly floats the first support stand with the help of the hovering means provided in first support stand 1. The hovering means, which is designed to float support stand 1 by supplying air pressure to the undersurface of support stand 1, is not shown in FIG. 1, but will be explained in detail later.

When floated in this manner using the hovering means, first support stand 1 can be moved in-plane within a prescribed small range by the operator gently pushing by hand the support stand or the axle module placed on the support stand. In addition, it is possible to actuate first support stand 1 so as to tilt it within a prescribed small range. In this manner, using a simple operating procedure, the mounting ends provided on axle module 11 can be matched with the mounting brackets provided on chassis frame 12. When matched, the mounting brackets are mated with the mounting ends.

At appropriate timing before or after that, the operator shuts off air pressure that floats first support stand 1 with the help of the hovering means. The hydraulic pressure in the cylinder means is maintained. As a result of this operation, axle module 11 is suspended by chassis frame 12. Such operations are carried out for front axle module 11(f) and rear axle module 11(r). By doing so, front and rear axle modules 11 are mounted to chassis frame 12.

Operators can perform the above-mentioned series of operations while maintaining a natural posture by appropriately setting the height of second support stand 2 that supports chassis frame 12. The height of second support stand 2 is typically set such that an operator standing on the floor can carry out operations in a natural standing posture without stooping, reaching up on tiptoes, or using a footstool.

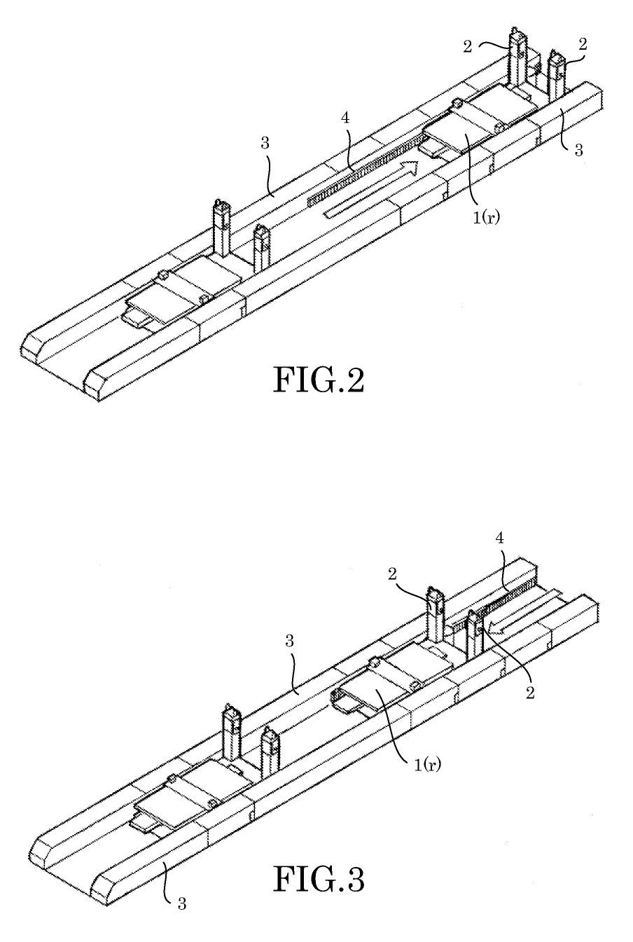

FIG. 2 and FIG. 3 are perspective views used to provide further explanations of the construction of the work stand. As shown in FIG. 2, a pair of parallel edges 3 are provided on the work stand. Rails 4 are provided on the internal wall surfaces of this pair of edges 3. In this manner, the position of first support stand 1 in the longitudinal direction can be varied without changing its angle relative to second support stand 2. Based on this construction, namely, by moving first support stand 1(r), which has a rear axle module placed thereon, in the direction of the arrow shown in FIG. 2, it is possible to accommodate vehicles with longer chassis frames. Conversely, first support stand 1(r) can accommodate vehicles with shorter chassis frames by moving in the direction of the arrow shown in FIG. 3.

In this embodiment, rails 4 and a corresponding construction (not shown in the figure) are provided only in the first support stand 1(r), on which the rear axle module is placed. Of the two first support stands 1, first support stand 1(r), which is used for the rear axle, is mechanically linked to rear second support stand 2, thereby allowing for changing the position of first support stand 1 and second support stand 2 in a linked fashion when adjusting the distance between the front and rear axles. Based on this construction, this device alone can accommodate a number of vehicle types with different distances between the front and rear axles.

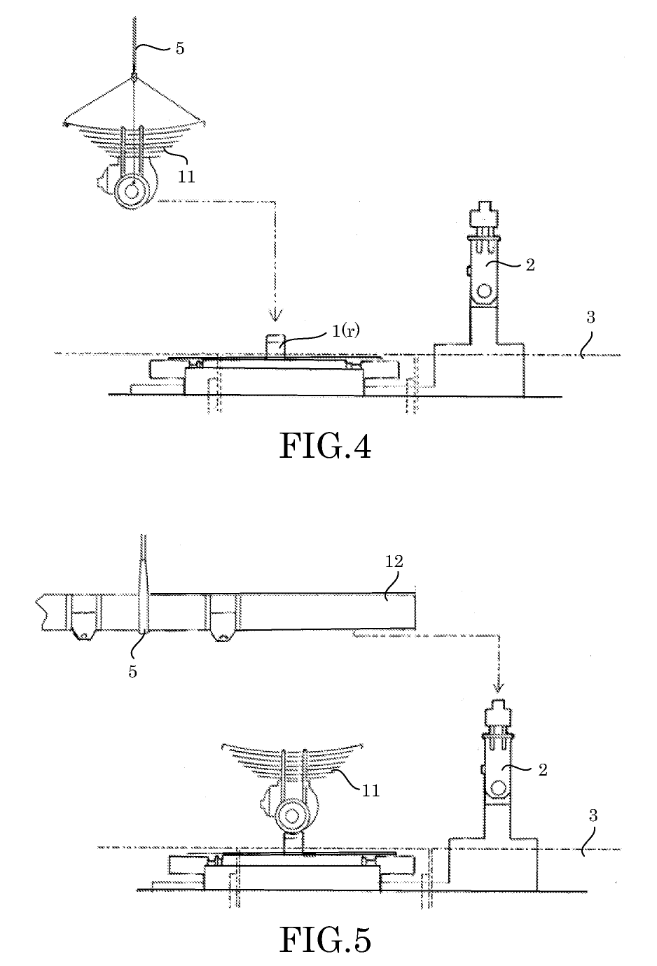

FIG. 4 shows how axle module 11 is transported into position on first support stand 1(r) using hoist 5. The dashed double dotted line shows the route of transport. The horizontal dashed dotted line at the bottom of the figure shows the height of edges 3. FIG. 5 shows how chassis frame 12 is transported into position on second support stand 2 using hoist 5. The tip of second support stand 2 is provided with L-shaped blocks, on which the chassis frame is placed. It should be noted that its position may be appropriately controlled by providing small holes or projections in chassis frame 12 to enable alignment with second support stand 2 by mating the small holes or projections with the tip of second support stand 2.

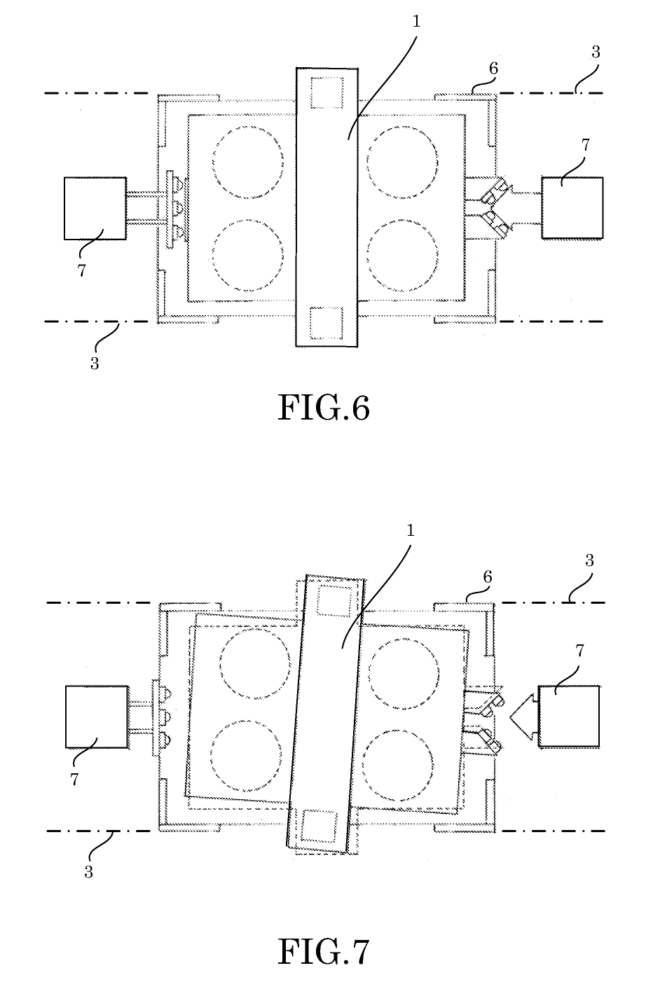

FIG. 6 and FIG. 7 are used to explain the centering mechanism of first support stand 1. As shown in FIG. 6, first support stand 1 is set in a fixed position by pushing a pair of actuating ends 7 inside. The axle module is transported in this state and then placed on first support stand 1. As shown in FIG. 7, by moving the above-mentioned pair of actuating ends 7 away to release the centering mechanism, first support stand 1 is brought into a mobile state, wherein it can move in-plane within a prescribed range. Bringing it into the mobile state permits alignment of the axle modules with the chassis frame in the subsequent steps.

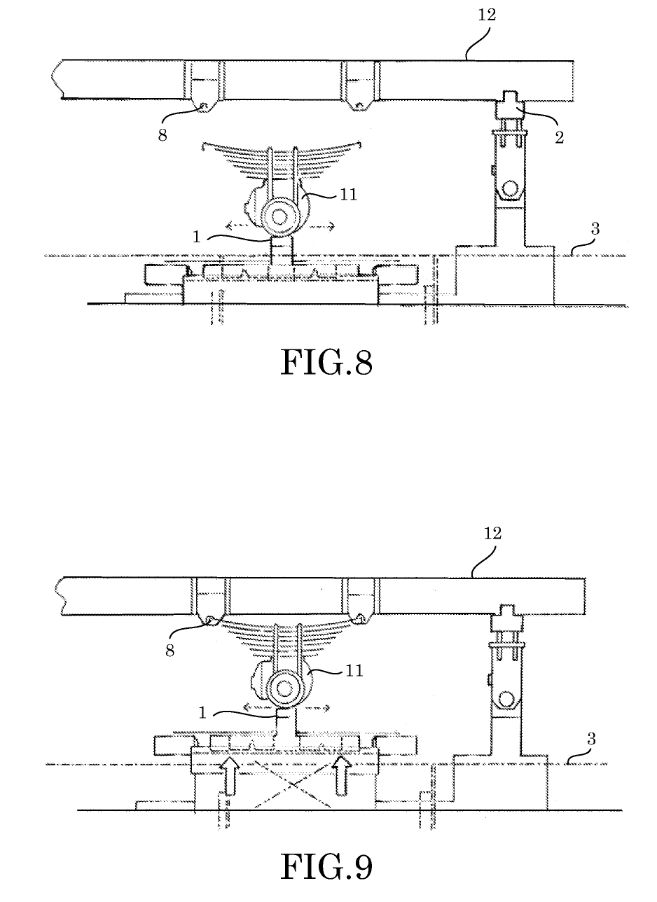

FIG. 8 and FIG. 9 are diagrams used to explain operations required for lifting axle module 11 relative to chassis frame 12. As shown in FIG. 8, axle module 11 is placed in a prescribed position on first support stand 1. By operating actuating ends 7 as described above, axle module 11 is substantially fixed in a preset prescribed position. According to the explanations for FIG. 5 above, the figure shows a side view of L-shaped blocks or small projections protruding upward from the second support stand 2 and supporting the sides of chassis frame 12. Therefore, the relative position of chassis frame 12 is fixed with respect to second support stand 2. By correctly placing axle module 11 on first support stand 1 and moving actuating ends 7 away to the sides so as to release it, first support stand 1 is brought into a mobile state, wherein it can move within a small range, as shown in FIG. 7.

This state is illustrated in FIG. 8. Namely, as shown by the dashed arrows, axle module 11 placed on first support stand 1 is brought into a transversely (and longitudinally) mobile state, in which it can move within a small range. Subsequently, as indicated by the hollow arrows shown at the bottom of FIG. 9, first support stand 1 is lifted upwards by supplying hydraulic pressure to the cylinder means, not shown. When brackets 8 used for mounting axle module 11 are brought into proximity to the mounting ends of chassis frame 12, first support stand 1 is slightly floated by activating the hovering means by performing appropriate actuating operations. In practical terms, its elevation is approximately 1 cm. As a result, operators can move axle module 11 within a small range vertically or in-plane and can engage the tips of the springs of axle module 11 with mounting brackets 8 provided on chassis frame 12. Conventional spring brackets are used to secure the mounting ends. These operations are carried out in succession in four locations, where the left and right ends of axle modules 11 are positioned. As a result of such operations, axle modules 11 are mounted to chassis frame 12.

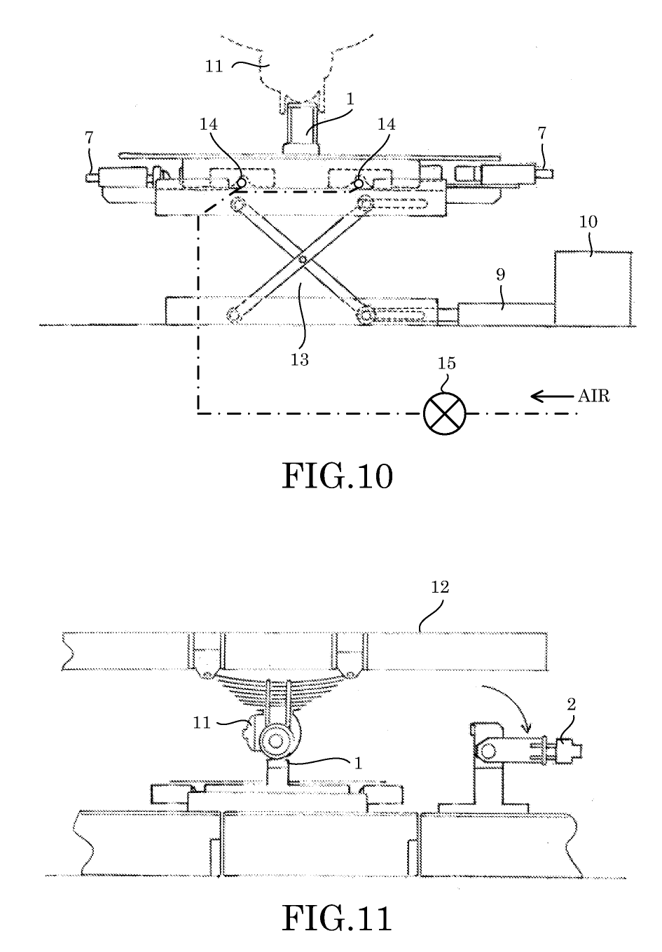

FIG. 10 is a lateral structural drawing explaining the main portion of the lifting mechanism provided in the device. Axle module 11 is placed on first support stand 1. As explained above, in order to perform alignment, actuating ends 7 are provided at the front and rear ends of first support stand 1. When an operator turns hydraulic pressure on by actuating a switch, not shown, hydraulic pressure is supplied to cylinder 9 from hydraulic unit 10. As a result, first support stand 1 is raised by cross-bar 13. When the mounting ends of axle module 11 placed thereon are brought into proximity to the mounting brackets of chassis frame 12, the operator actuates the switch to maintain the state of hydraulic pressure in chassis frame 12. Subsequently, air pressure is delivered to a plurality of air pressure nozzles 14 provided in the space underneath first support stand 1 by actuating air pressure valve 15 so as to set it to an open state. The air pressure supplied from the air pressure nozzles 14 creates a state, wherein an air barrier is formed in the space underneath first support stand 1 and, as a result, first support stand 1 is slightly floated. This is the hovering means and its operation.

While the hovering means is in operation, first support stand 1 is slightly raised (about 1 cm). At such time an operator can freely change the horizontal position and vertical position of axle module 11 within a small range by pushing it with his hand, etc. In this state, as explained in FIG. 8, the mounting ends provided on axle module 11 can be matched with mounting bracket 8 provided on chassis frame 12. This operation is carried out on mounting ends located in four places, i.e. at the right and left end as well as at the front and rear end. Upon completion of mounting to mounting brackets 8, air pressure valve 15 is set to a closed state. First support stand 1 is kept at this height by maintaining the hydraulic pressure supplied to cylinder 9 for a while.

Referring now to FIG. 11, in this state, chassis frame 12 is held on first support stand 1, with the axle module 11 placed therebetween. Here, second support stand 2 can be disabled by slightly raising first support stand 1 and tilting second support stand 2 as shown in FIG. 11. This is done in order to perform the subsequent process operations, namely, engine/module mounting, wheel mounting, and the like on chassis frame 12. Upon completion of wheel mounting, hydraulic pressure in cylinder 9 is reduced and first support stand 1 is lowered. At such time, chassis frame 12 is supported by the wheels.

The hydraulic unit 10 and hydraulic cylinder 9 described above were assembled from general-purpose components. In addition, in this embodiment, the hovering means was assembled from parts ordered from a catalog. The use of the hovering means in order to make fine position adjustments is one of the elements of the present invention, but the construction of the hovering means, in which air pressure is supplied between two plate-shaped members and a barrier is formed with the help of the air pressure, is not novel in and of itself. Therefore, details regarding its construction are omitted.

It should be noted that despite the fact that examples provided in the preceding explanations used a hydraulic cylinder as a lifting mechanism, the mechanism may also be based on the use of air, electricity, etc.

### INDUSTRIAL APPLICABILITY

In its applications, the present invention is not limited to the vehicle assembly method disclosed in the above-mentioned prior application and can be implemented in various other methods, in which axle modules are assembled with the vehicle held in normal orientation.

1. A work method for axle module mounting, comprising:
a first step of placing an axle module on a first support stand in normal orientation,
a second step of placing a chassis frame on a second support stand in normal orientation such that the chassis frame is positioned above the axle module, and
a third step of raising the first support stand to bring mounting ends on the axle module in proximity to mounting ends on the chassis frame.

2. The work method for axle module mounting according to claim 1, wherein the third step comprises using cylinder means to raise the first support stand.

3. The work method for axle module mounting according to claim 1, wherein the third step comprises using hovering means to float the first support stand.

4. The work method for axle module mounting according to claim 1, wherein the third step comprises using cylinder means to raise the first support stand and then using hovering means to float the first support stand.

5. An axle module mounting device comprising:
a first support stand for placing an axle module in normal orientation;
a second support stand for placing a chassis frame such that the chassis is positioned above the axle module placed on the first support stand; and
raising means for raising the first support stand, with the axle module placed thereon, to a position used for mounting to a chassis frame.

6. The axle module mounting device according to claim 5, wherein
the first support stand has a separately provided front wheel support stand for placing a front wheel axle module thereon and a rear wheel support stand for placing a rear wheel axle module thereon, and
the raising means is provided in the front wheel support stand and in the rear wheel support stand, respectively, and there is provided means for individually actuating the respective raising operation.

7. The axle module mounting device according to claim 6, comprising means for adjusting the distance between the front wheel support stand and the rear wheel support stand.

8. The axle module mounting device according to claim 6, wherein the raising means comprises cylinder means.

9. The axle module mounting device according to claim 6, wherein the raising means comprises hovering means.

10. The axle module mounting device according to claim 6, wherein the raising means comprises both cylinder means and hovering means and comprises actuating means for respectively individually actuating either one of the cylinder means or hovering means.

11. The axle module mounting device according to claim 6, wherein the height of the second support stand from the surface of the floor is greater than the radius of the wheels to be mounted on the axle module and is set to a height allowing operators standing on the surface of the floor to access a chassis frame placed on the second support stand.

12. The axle module mounting device according to claim 6, wherein the second support stand comprises two pairs of support posts supporting a pair of longitudinally-oriented members forming part of a chassis frame.

13. The axle module mounting device according to claim 12, comprising means for adjusting the distance between the two pairs of support posts.

14. The axle module mounting device according to claim 13, wherein the means for adjusting the distance between the two pairs of support posts comprises means for associating it with means for adjusting the distance between the front wheel support stand and the rear wheel support stand.
